(19) United States
(12) Patent Application Publication
(10) Pub. No.: US 2014/0320611 A1
(43) Pub. Date: Oct. 30, 2014

(54) Multispectral Multi-Camera Display Unit for Accurate Color, Multispectral, or 3D Images

(71) Applicant: nanoLambda Korea, Daejeong (KR)

(72) Inventor: Byung Il Choi, Pittsburgh, PA (US)

(73) Assignee: nanoLambda Korea, Daejeong (KR)

(21) Appl. No.: 14/263,040

(22) Filed: Apr. 28, 2014

Related U.S. Application Data
(60) Provisional application No. 61/816,939, filed on Apr. 29, 2013.

(51) Int. Cl. H04N 5/33; H04N 5/232; H04N 9/04; H04N 13/02

(52) U.S. Cl. CPC H04N 5/332; H04N 13/0242; H04N 5/23293; H04N 9/04
USPC 348/47; 348/163

(57) ABSTRACT

In one aspect, a multispectral multi-camera display unit is disclosed, including a display unit, a camera array, and an image integration processing unit. In some embodiments, the camera array is configured such that at least one camera is located at each of two or more sides of the display unit. In some embodiments, each camera comprises a color image sensor or multispectral imager.

### CROSS REFERENCE TO RELATED APPLICATIONS

The present application claims the benefit of U.S. Provisional Patent Application No. 61/816,939 filed Apr. 29, 2013, the entire contents of which is incorporated herein by reference.

### BACKGROUND OF THE INVENTION

There have been rapidly growing demands and efforts to develop a low-cost snapshot multi spectral imager for applications such as accurate color reproduction, machine/robot vision, plant and vegetation research, food processing, counterfeit detection, early stage diagnosis of cancer, medical in-vivo imaging, and defense applications (point/stand-off optical spectral detection systems for remote sensing). Especially the demand for accurate color reproduction is highly desired with growing number of smart displays equipped with color camera modules and color displays.

A typical multispectral imager may be made from, e.g., rotating filter wheels or mechanically diced thin-film dichroic filters mounted in front of an image sensor, or multiple cameras with bulk dichroic filters. Even for those touted as commercial systems, there may be no effective volume production pathway with significant price or reduced complexity enhancements at even as few as tens or hundreds of units.

### SUMMARY OF THE INVENTION

A multispectral multi-camera display unit made of multiple cameras around the display unit for accurate color image, 3D image and multispectral image for health monitoring is presented. The multispectral camera presented uses monolithic filter array layer as multispectral mosaic pattern. The emitting light is also modulated to generate a specific spectral light.

The inventors have realized that multiple multispectral imagers of the type described herein may be used at one display unit with a conductive layer including a periodic pattern of elements as multispectral filter mosaic pattern. This way, the multispectral multi-camera display unit, not only can acquire accurate color images, multispectral images but also can acquire 3D images at the same time. The multispectral images acquired can also be used for health monitoring of the human, face and any part of body.

In one aspect, a multispectral multi-camera display unit is disclosed, including: a display unit, a camera array; and an image integration processing unit. In some embodiments, the camera array is configured such that at least one camera is located at each of two or more sides of the display unit. In some embodiments, each camera comprises a color image sensor or multispectral imager.

In another aspect, a method is disclosed including the steps of: providing a multispectral multi-camera display unit, comprising: a display unit; a multispectral camera array comprising two or more cameras; and an image integration processing unit; wherein the camera array is configured such that at least one camera is located at each of at least two sides of the display unit. In some embodiments the method includes the steps of: processing images from different cameras of the array with the image integration processing to generate a display image; and displaying the display image on the display unit.

### BRIEF DESCRIPTION OF THE DRAWINGS

FIG. 1 is a schematic representation of a multispectral multi-camera display unit with embedded multiple camera units along multiple sides of the display unit;

FIG. 2 is a schematic representation of a multispectral multi-camera display unit with embedded multiple camera units, separated from but attached along the sides of the display unit;

FIG. 3A is a schematic representation of a camera unit with RGB color filters;

FIG. 3B is a schematic representation of an RGB color filter from FIG. 3A;

FIG. 3C shows the response plot for the RGB color filter from FIG. 3A;

FIGS. 4A, 4B and 4C show response plots for different types of multispectral band pass filters for multispectral image;

FIG. 5A is a schematic representation of a multispectral imager with monolithically integrated multispectral filter array with a mosaic pattern; and

FIG. 5B is a schematic representation of a spectral response of a multispectral filter array.

### DETAILED DESCRIPTION OF THE PREFERRED EMBODIMENTS

Unless otherwise specified, the words “a” or “an” as used herein mean “one or more”. The term “light” includes visible light as well as ultraviolet (UV) and infrared (IR) radiation. The disclosure includes the following embodiments.

As used herein, the term “multispectral” refers to images containing information content related to more than one wavelength band of incident light. For example, well know RGB sensors produce multispectral images information content related to three wavelength bands corresponding to red, green, and blue visible light. Other multispectral images may include information content related to two bands of light or more than three bands of light. In some cases multispectral images may include information content related to more than one wavelength bands outside of the visible spectrum (e.g., UV or IR).

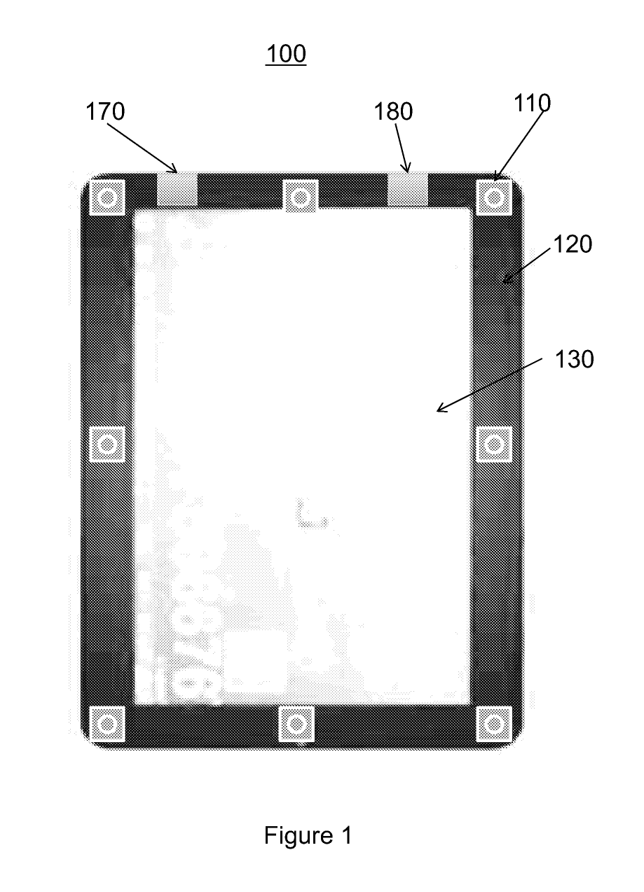

In FIG.1, a multispectral multi-camera display unit 100 for accurate color, multispectral, or 3D images, is shown containing imager units 110, each including, e.g., a set of one more cameras or multispectral cameras. The multispectral multi-camera display unit 100 includes a multi sided frame 120, and display unit 130. As shown, eight imager units 110 are provided mounted in the multi sided frame 120 with one imager unit 110 disposed in each corner of the frame 110 and one imager unit 110 disposed on a side of the frame 110 between two corners of the frame 110. However, in various embodiments, any suitable number of imager units 110 may be used (e.g., one, two, three, four, five, six seven, eight, nine, ten or more, such as 1-100 or any sub-range thereof). In various embodiments, the multi sided frame 120 may have any suitable number of sides used (e.g., two, three, four, five, six seven, eight, nine, ten or more, such as 1-100 or any sub0range thereof). In various embodiments, the imager units 110 may be disposed at any suitable locations on the multi sided frame 120.

In some embodiments, the imager unit 110 may be a multispectral imager unit. For example, in some embodiments the imager unit 110 may include one or more black and white image sensors paired with one or more band pass filters. In some embodiments the imager unit 110 may include a color image sensor (e.g. an RGB image sensor) with embedded filter array, such as an RGB Bayer pattern filter array. In some embodiments the imager unit 110 may include a multispectral imager. In some embodiments the multispectral imager may include multiple band pass filters, e.g., more than one, more than two, more than three, or more band pass filters.

In various embodiments, the display unit 130 may be any suitable type of display unit including, e.g., an LCD or plasma display, a touch sensitive display, a 3D display, or combinations thereof.

In various embodiments, the multispectral multi-camera display unit 100 may include a processor (not shown) in communication with the imager units 110 and the display unit 130. In some embodiments, the processor may process signals from the imager units 110 to generate an image (e.g., accurate color, multispectral, or 3D image) for display on the display unit 130.

For example, in some embodiments, the processor my include an image integration processing unit that merges the images from different imager units 110 to form an image, e.g., a mirror-like non-distorted image using the separation distance information among the imager units 110. In some embodiments, the image integration processing unit merges the images from the imager units 110 to form a natural color image utilizing different spectral information of each camera.

In some embodiments, the image integration processing unit merges the images from different imager units 110 to form a multispectral image of, e.g., a human, face, body or any part of the body. In some embodiments, multispectral image is used to interpret the health condition of the human, face or any part of the body. For example, infrared information from the image may be used to identify regions of elevated temperature indicative of a disorder such as a bacterial infection.

In some embodiments, the image integration processing unit merges the images from different imager units 110 of the array to form a 3D image.

In some embodiments, the multispectral multi-camera display unit 100 may include a light source 170. In some embodiments, the light source generates output light with selected spectral content. For example, in some embodiments, the light source 170 includes a plurality of light sub-sources (e.g., LEDs) each generating light at different wavelengths or wavelength ranges. These sub-sources may be modulated (e.g., as controlled by the processor) so that the overall output of the light source 170 has selected spectral content.

In some embodiments, the multispectral multi-camera display unit 100 may include an ambient spectral light sensor 180 that detects information related to the ambient spectral background information of the environment and provides this information to the processor (e.g., for use in generating images for display on the display unit 130).

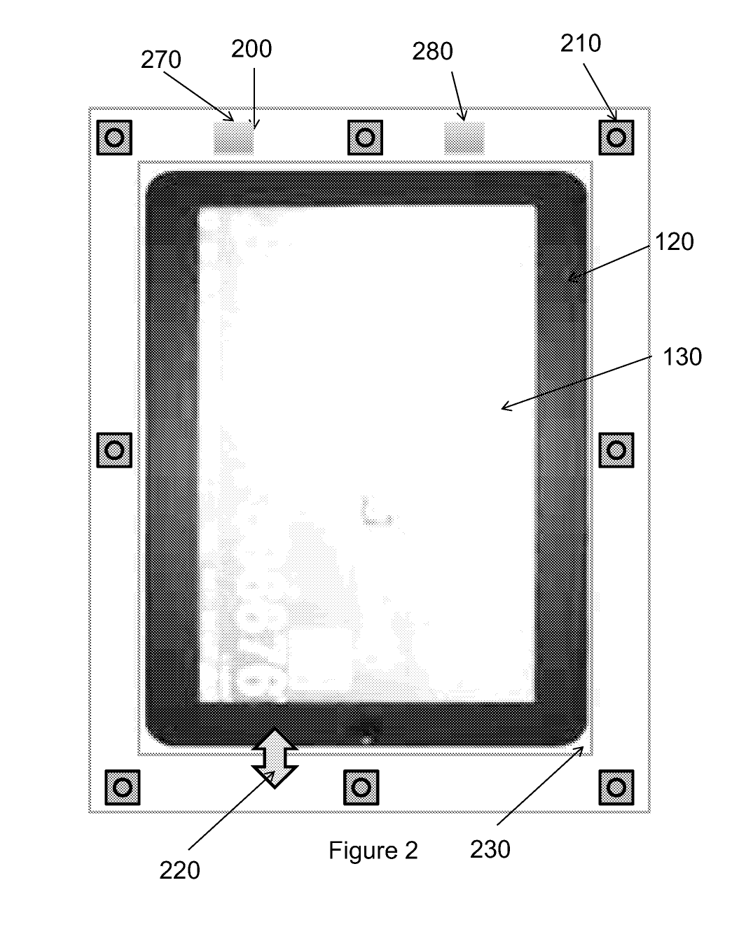

In FIG.2, a multispectral multi-camera unit 200 for accurate color, multispectral, or 3D images, is shown containing a set imager units 210 each including, e.g., a set of one or more cameras or multispectral cameras. As shown, eight imager units 210 are provided mounted in the multi-camera unit 200 with one imager unit 210 disposed in each corner of the multi-camera unit 200 and one imager unit 210 dispose on a side of the multi-camera unit 200 between two corners of the multi-camera unit 200. However, in various embodiments, any suitable number of imager units 110 may be used (e.g., two, three, four, five, six seven, eight, nine, ten or more, such as 1-100 or any sub-range thereof) disposed at any suitable positions.

The multispectral multi-camera unit 200 may have an operative connection 220 to the display unit 130. The connection may be a wired connection (e.g., a USB connection), a wireless (e.g., a Bluetooth or WiFi connection), and optical connection (e.g., an Ethernet connection), or any other suitable connection.

The display unit 130 may include a display frame 120. In various embodiments, the display frame 120 may have any suitable number of sides used (e.g., one, two, three, four, five, six seven, eight, nine, ten or more, such as 1-100 or any sub-range thereof). The multispectral multi-camera unit 200 may have a frame receptacle 230 that may be attached and fit to the display unit frame 120. Various embodiments may include one or more attachment devices used to secure the display unit 130 in the receptacle 230. The attachment devices may include, e.g., a latch, a magnetic attachment, a hook and loop attachment, a frictional attachment, or any other suitable attachment device.

In some embodiments, the imager unit 210 may be a multispectral imager unit. For example, in some embodiments the imager unit 210 may include one or more black and white image sensors paired with one or more band pass filters. In some embodiments the imager unit 210 may include a color image sensor (e.g. an RGB image sensor) with embedded filter array, such as an RGB Bayer pattern filter array. In some embodiments the imager unit 210 may include a multispectral imager. In some embodiments the multispectral imager may include multiple band pass filters, e.g., more than one, more than two, more than three, or more band pass filters.

In various embodiments, the a multispectral multi-camera unit 200, the display unit 130, or both, may include one or more processor (not shown) in communication with the imager units 210 and the display unit 130. In some embodiments, the processor may process signals from the imager units 210 to generate an image (e.g., accurate color, multispectral, or 3D image) for display on the display unit 130. In various embodiments the processors may perform any of the image processing functions described above with reference to the multispectral multi-camera unit 100 of FIG. 1.

In some embodiments, the multi-camera unit 200, the display unit 130, or both, may include a light source 270 and/or an ambient spectral light sensor 180 of the type described above with reference to the multispectral multi-camera unit 200 of FIG. 1.

In various embodiments, the display unit 130 may be any suitable type of display unit including, e.g., an LCD or plasma display, a touch sensitive display, a 3D display, or combinations thereof.

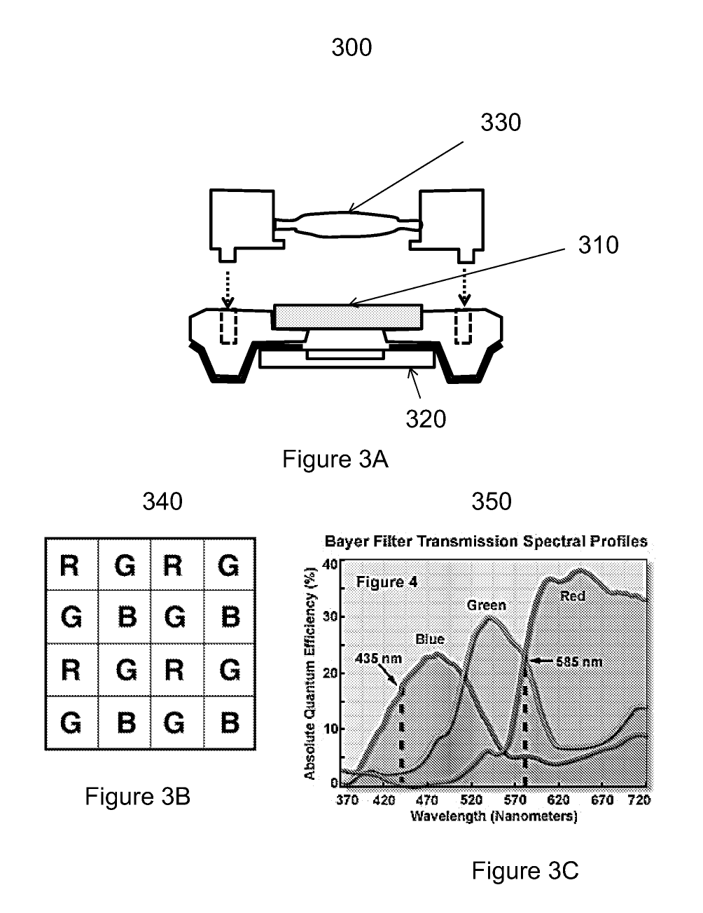

In FIG. 3A, a multispectral unit 300 for accurate color, multispectral, or 3D images, is shown containing an image sensor 320, a filter 310, and an input optical unit 330. The filter 310 may be e.g., a band pass filter or cut off filter or high or low pass filter. The optical unit may include one or more optical elements such as a set of lens as input optics 330. For example, in some embodiments, the input optical unit 330 may be configured to image an object of interest through the filter 310 onto the image sensor 320. However, in various embodiments the optical unit 330 may include any suitable number and combination of refractive, diffractive, reflective, holographic, or other optical elements.

In some embodiments, the image sensor 320 may be a black and white image sensor, such as a CCD or CMOS sensor. In some embodiments, the image sensor may be a color image sensor such as an RGB image sensor. For example, the image sensor 320 may be an RGB sensor with embedded filter such an RGB Bayer pattern filter array. For example, as shown in FIG. 3B, the RGB Bayer pattern filter array 340 may include a color filter array that passes red (R), green (G), or blue (B) light to selected pixel sensors (e.g., corresponding to regions of a black and white CCD or CMOS detector), forming interlaced grids sensitive to red, green, and blue. FIG. 3C shows an exemplary Bayer Filter transmission spectral profile 350 for the filter 340.

In some embodiments, the imager sensor 320 may be a multispectral imager with any suitable number of embedded band pass filters (e.g., more than one, more than two, more than three, or more band pass filters).

In some embodiments, e.g., where the image sensor 320 includes one or more embedded filters, the separate filter 310 may be omitted.

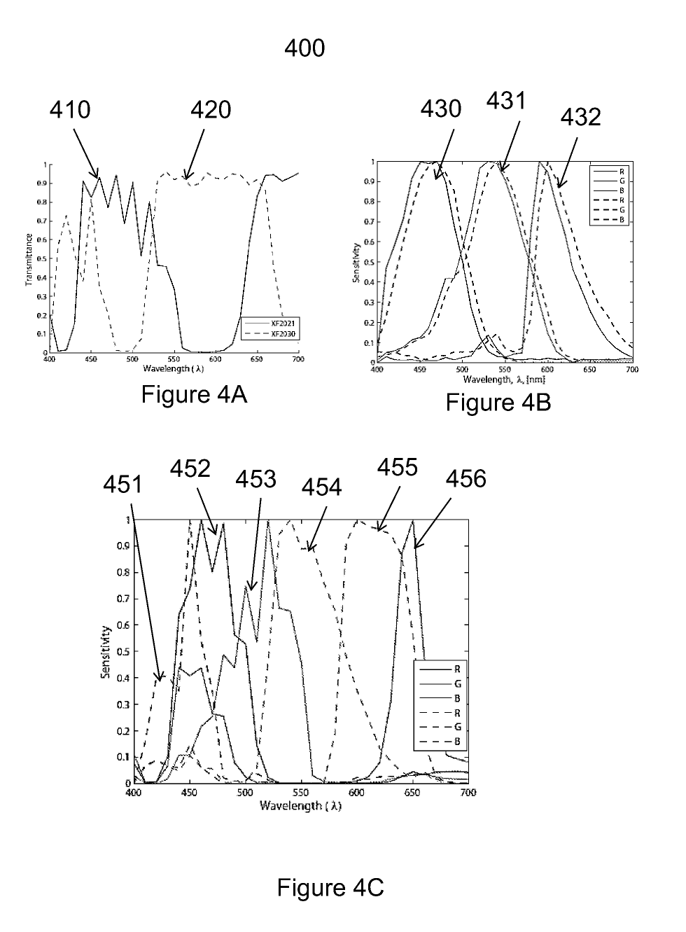

In general, any suitable filter may be used for filter 310 or an embedded filter in the image sensor 320. FIGS. 4A, 4B and 4C, show plots 410, 420, 430, 431, 432, 451, 452, 453, 454, 455 and 456 of transmission or sensitivity as a function of wavelength for various examples of different types of filter in the visible range. For example, FIG. 4A shows transmission plots 410, 420 for a pair of filters suitable for passing wavelengths in the range of about 450 nm to about 525 nm and the range of about 550 nm to about 675 nm respectively. FIG. 4B shows sensitivity plots 430, 431, and 432 for a set of filters configured to pass red, green and blue light, respectively. FIG. 4BC shows sensitivity plots 451, 452, 453, 454, 455 and 456 for a set of filters configured to divide the visible spectrum into six distinct passbands.

In various embodiments, filter 310 or one or more filters embodied in the image sensor 320 may be formed as a layer or layers of highly conductive structured materials. The highly conductive structured material layer may include a periodic pattern or patterns of elements (e.g. nanoscale or micron scale elements). The elements have shapes and sizes configured such that a transmittance spectrum of the conductive layer has at least one pass band within a target wavelength range, e.g., due to the plasmonic behavior of the elements. Exemplary filters are described in International Pub. No. WO/2012/040466, SPECTRUM RECONSTRUCTION METHOD FOR MINIATURE SPECTROMETERS, published Mar. 29, 2012; International Pub. No. WO/2010/108086, NANO-OPTIC FILTER ARRAY BASED SENSOR, published Sep. 23, 2010; International Pub. No. WO/2009/009077, DIGITAL FILTER SPECTRUM SENSOR, published Jan. 15, 2009; International Pub. No. WO/2008/147403 TUNABLE PLASMONIC FILTER, published Dec. 4, 2008; International Pub. No. WO/2008/082569 WAVELENGTH SELECTIVE METALLIC EMBOSSING NANOSTRUCTURE, published Jul. 10, 2008; and International Pub. No. WO/2008/085385, PLASMONIC FABRY-PEROT FILTER, published Jul. 17, 2008; the entire contents of each of which are incorporated herein by reference.

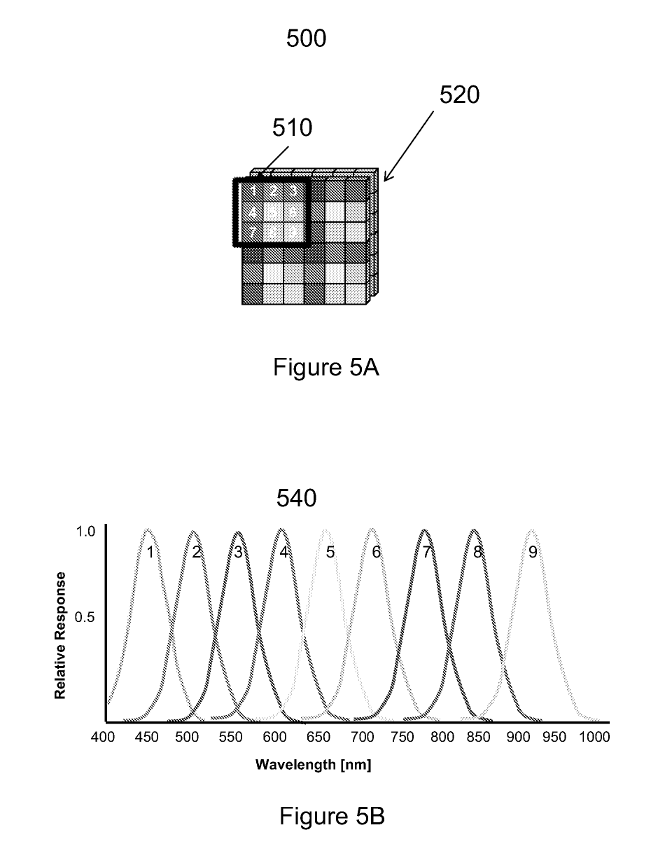

In FIG. 5A, an example of multispectral imager 500 is shown, including filter array mosaic pattern 510 of multispectral imager, and a detector 520 with associated pixel array. As shown, the mosaic pattern 510 includes a repeating pattern of nine different band pass filters (labeled 1, 2, 3, 4, 5, 6, 7, 8, and 9) arranged in a 3×3 block. Each band pass filter has an associated pixel (or detector region) on the detector 520.

FIG. 5B shows a plot 540 showing the response of the pixel associated with each band pass filter in the mosaic 510. As shown, each pixel in responsive to a substantially distinct portion of spectrum over a range of wavelengths extending from the UV to the infrared.

Although in the example shown nine different band pass filters arranged in a 3×3 repeating pattern are used, and other suitable number of filters in any suitable pattern may be used. For example, in some embodiments any number of filters, e.g., one to sixteen or more, may be used. In some embodiments, the filters may be arranged in a mosaic pattern having repeating blocks of filters such as 2×2, 2×3, 3×2, 3×3 (as shown), 4×3, 3×4 or 4×4 blocks.

In some embodiments, each of the band pass filters in the mosaic pattern 510 may be made of a layer or layers of highly conductive structured materials. The highly conductive structured material layer may include a periodic pattern or patterns of elements (e.g., nano-scale or micron scale elements). The elements have shapes and sizes configured such that a transmittance spectrum of the conductive layer has at least one pass band within the target wavelength range, e.g., due to the plasmonic behavior of the element. Exemplary filters are described in the publications incorporated by reference above.

In various embodiments, the multispectral imagers 300, 400 and 500 shown in FIGS. 3A, 4A and 5A may be incorporated in the imager units 110 and 210 shown in FIGS. 1 and 2.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

All of the publications, patent applications and patents cited in this specification are incorporated herein by reference in their entirety.

What is claimed is:

1. A multispectral multi-camera display unit, comprising:
a display unit;
a multispectral camera array comprising two or more cameras; and
an image integration processing unit;
wherein the camera array is configured such that at least one camera is located at each of at least two sides of the display unit.

2. The multispectral multi-camera display unit of claim 1, wherein:
the multispectral camera array comprises a plurality of black and white image sensors and wherein each black and white image sensor comprises a filter having a respective wavelength bandpass response.

3. The multispectral multi-camera display unit of claim 1, wherein at least one camera comprises a multispectral imager.

4. The multispectral multi-camera display unit of claim 3, wherein the multispectral imager comprises an RGB image sensor.

5. The multispectral multi-camera display unit of claim 3, wherein the multispectral imager comprises a multispectral imager configured to detect more than three spectral bands.

6. The multispectral multi-camera display unit of claim 3, wherein the multispectral imager comprises a plasmonic filter.

7. The multispectral multi-camera display unit of claim 3, wherein the multispectral imager comprises a filter comprising a mosaic of band pass filters.

8. The multispectral multi-camera display unit of claim 3, wherein the multispectral imager comprises a filter comprising a conductive layer including a periodic pattern of elements, wherein the elements have shapes and sizes configured such that a transmittance spectrum of the conductive layer has at least one band within the target wavelength range.

9. The multispectral multi-camera display unit of claim 1, wherein:
the image integration processing unit merges the images from different cameras of the array to form a mirror-like non-distorted image using the separation distance information among cameras, and
the image integration processing unit merges the images from different cameras of the array to form a natural color image utilizing the different spectral information of each camera.

10. The multispectral multi-camera display unit of claim 1, wherein:
the image integration processing unit merges the images from different cameras of the array to form a multispectral image of at least a portion of the body of a human or animal subject, and
the multispectral image is used to generate information indicative of the health condition of the subject.

11. The multispectral multi-camera display unit of claim 1, wherein the image integration processing unit merges the images from different cameras of the array to form a 3D image.

12. The multispectral multi-camera display unit of claim 1, further comprising a light source comprising a plurality of LEDs each configured to output different wavelengths of light, and wherein the LEDs are configured to be modulated to generate a combined output with a selected spectral content.

13. The multispectral multi-camera display unit of claim 1, further comprising an ambient spectral light sensor configured provide the spectral background information of an environment of the multi-camera display unit.

14. The multispectral multi-camera display unit of claim 1, wherein the display unit comprises:
a first detachable portion comprising a display;
a second detachable portion comprising:
a frame comprising the multispectral camera array;
a receptacle for receiving the first detachable portion; and
a communications link between the first and second detachable portions.

15. A method comprising:
providing a multispectral multi-camera display unit, comprising:
a display unit;
a multispectral camera array comprising two or more cameras; and
an image integration processing unit;
wherein the camera array is configured such that at least one camera is located at each of at least two sides of the display unit; and
processing images from different cameras of the array with the image integration processing to generate a display image;
displaying the display image on the display unit.

16. The method of claim 15, wherein processing images from different cameras of the array with the image integration processing to generate a display image comprises:
merging the images from different cameras of the array to form a mirror-like non- distorted image using the separation distance information among cameras.

17. The method of claim 15, wherein processing images from different cameras of the array with the image integration processing to generate a display image comprises:
merging the images from different cameras of the array to form a natural color image utilizing the different spectral information of each camera.

18. The method of claim 15, wherein processing images from different cameras of the array with the image integration processing to generate a display image comprises:
merging the images from different cameras of the array to form a multispectral image of at least a portion of the body of a human or animal subject, and
processing the multispectral image is used to generate information indicative of the health condition of the subject.

19. The method of claim 15, wherein processing images from different cameras of the array with the image integration processing to generate a display image comprises:
merging the images from different cameras of the array to form a 3D image.

20. The method of claim 15, wherein:
the multispectral multi-camera display comprises a light source comprising a plurality of LEDs each configured to output different wavelengths of light, and
further comprising modulating the LEDs to generate a combined output with a selected spectral content.

21. The method of claim 15, further comprising:
using an ambient spectral light sensor to generate information indicative of the spectral background information of an environment of the multi-camera display unit.

22. The method of claim 15, wherein the display unit comprises:
a first detachable portion comprising a display; and
a second portion comprising:
a frame comprising the multispectral camera array; and
a receptacle for receiving the first detachable portion; and
wherein the method further comprises:
attaching the first and second detachable portions; and
establishing a communications link between the first and second detachable portions.
